(19) United States
(12) Patent Application Publication
(10) Pub. No.: US 2017/0216999 A1
(43) Pub. Date: Aug. 3, 2017

(54) POWER TOOL WITH A DOUBLE OPERATIONAL STRUCTURE

(71) Applicant: Ming-Ta CHENG, Taichung City (TW)

(72) Inventor: Ming-Ta CHENG, Taichung City (TW)

(21) Appl. No.: 15/011,435

(22) Filed: Jan. 29, 2016

(51) Int. Cl. B25B 21/00; B25F 5/00

(52) U.S. Cl. CPC B25B 21/002; B25F 5/001

(57) ABSTRACT

A power tool has a handle, a tool body, a rotator, a first working unit, and a second working unit. The handle has a handle body, a mounting ring rotatably mounted around the handle body, and a switch mounted on the mounting ring and inserted into the handle body. The tool body is mounted on the handle. The rotator is mounted in the tool body, and has a first driving end and a second driving end. The first working unit is mounted in the tool body, and is mounted around and engaged with the rotator. The second working unit is mounted in the tool body, and is mounted around and engaged with the rotator.

### BACKGROUND OF THE INVENTION

1. Field of the Invention

The present invention relates to a power tool, and more particularly to a power tool with a double operational structure.

2. Description of Related Art

A conventional power tool for vehicle assembling comprises a handle, a tool body, a rotator, and a working unit. The tool body is connected with the handle. The rotator and the working unit are mounted in the tool body. The working unit is driven by the rotator, and comprises a connector protruding out of the tool body.

When the conventional power tool is applied for tightening or loosening a bolt, the conventional power tool is first applied for a part of a working process, and then a different tool is replaced with the conventional power tool to complete the rest part of the working process. For example, to tighten a bolt, the conventional power tool is first applied to slightly tighten the bolt, and then the conventional power tool is replaced with another torque wrench to tightly tighten the bolt. In the working process, the user has to use different tools to complete the working process, and this is inconvenient in operation.

### SUMMARY OF THE INVENTION

The main objective of the present invention is to provide a power tool to resolve the aforementioned problems.

The power tool comprises a handle, a tool body, a rotator, a first working unit, and a second working unit.

The handle comprises a handle body, a mounting ring rotatably mounted around the handle body, and a switch mounted on the mounting ring and inserted into the handle body.

The tool body is mounted on the handle, and comprises an accommodating space formed in the tool body.

The rotator is mounted in the accommodating space, and comprises a first driving end formed on an end of the rotator, and a second driving end opposite the first driving end.

The first working unit is mounted in the accommodating space, mounted around and engaged with the first driving end, and comprises a first working connector protruding out from the tool body.

The second working unit is mounted in the accommodating space, is mounted around and engaged with the second driving end, and comprises a second working connector protruding out from the tool body.

Other objectives, advantages and novel features of the present invention will become more apparent from the following detailed description when taken in conjunction with the accompanying drawings.

### BRIEF DESCRIPTION OF THE DRAWINGS

FIG. 1 is a perspective view of a preferred embodiment of a power tool in accordance with the present invention;

FIG. 2 is a partial side view in cross section of the power tool in FIG. 1;

FIG. 3 is an enlarged partially exploded perspective view of the power tool in FIG. 1;

FIG. 4 is a partially enlarged side view in cross section of the power tool in FIG. 1;

FIG. 5 is an enlarged partially exploded perspective view of the power tool in FIG. 1;

FIG. 6 is a partially enlarged side view in cross section of the power tool in FIG. 1;

FIG. 7 is an enlarged partially exploded perspective view of the power tool in FIG. 1; and

FIG. 8 is a partial side view in cross section of a conventional power tool.

### DETAILED DESCRIPTION OF PREFERRED EMBODIMENT

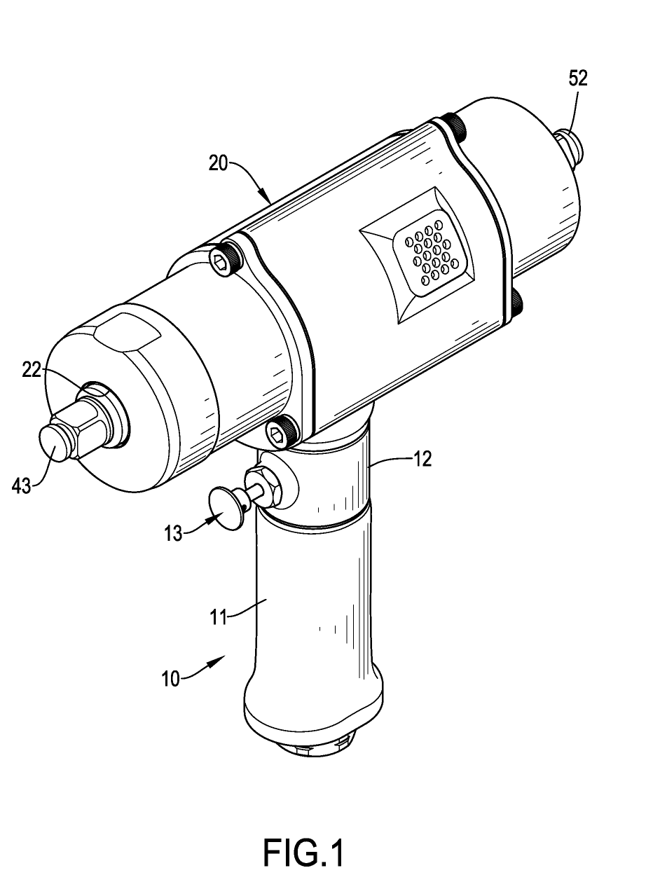

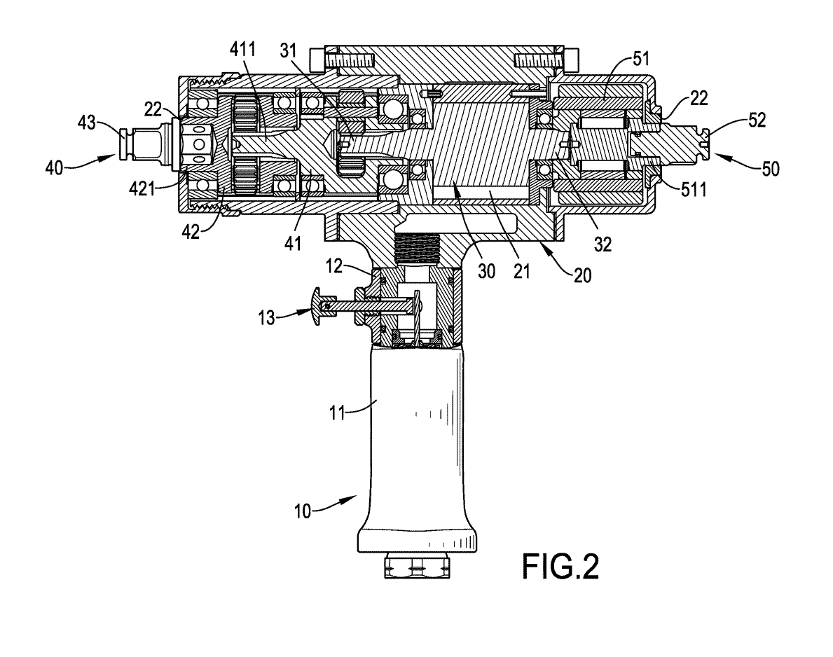

With reference to FIGS. 1 to 2, a preferred embodiment of a power tool with a double operational structure comprises a handle 10, a tool body 20, a rotator 30, a first working unit 40, and a second working unit 50.

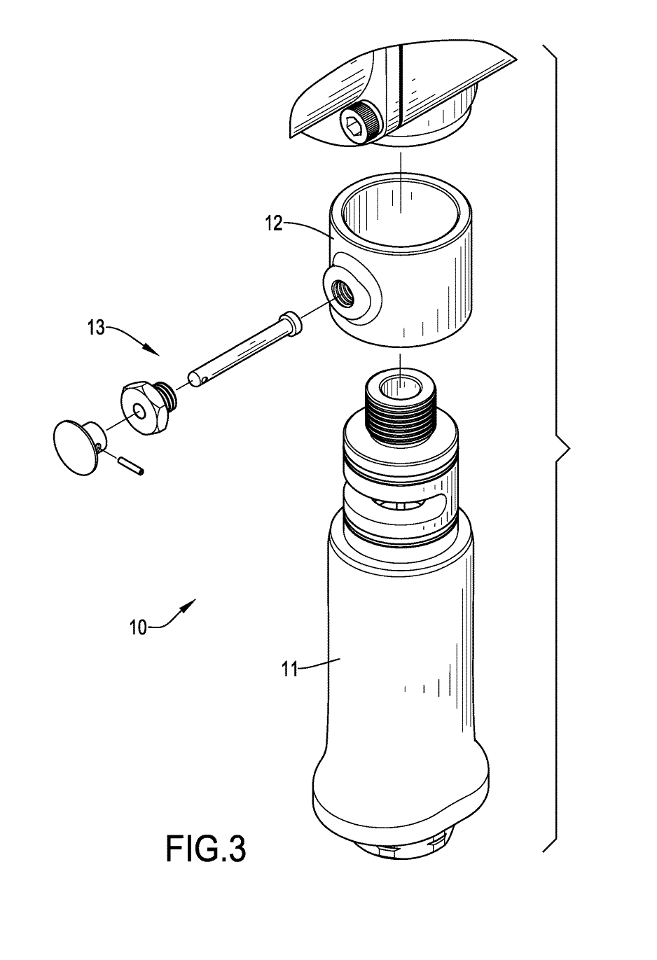

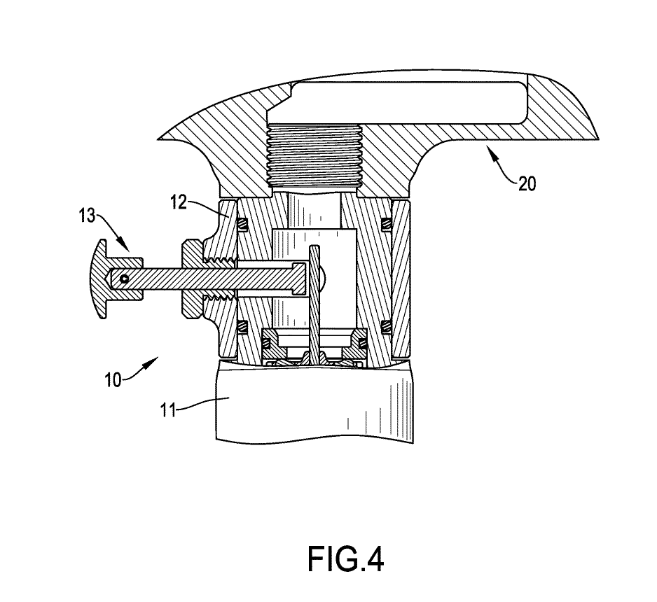

With reference to FIGS. 3 and 4, the handle 10 comprises a handle body 11, a mounting ring 12, and a switch 13. The handle body 11 is elongated. The mounting ring 12 is rotatably mounted around the handle body 11. The switch 13 is mounted on the mounting ring 12 and is inserted into the handle body 11.

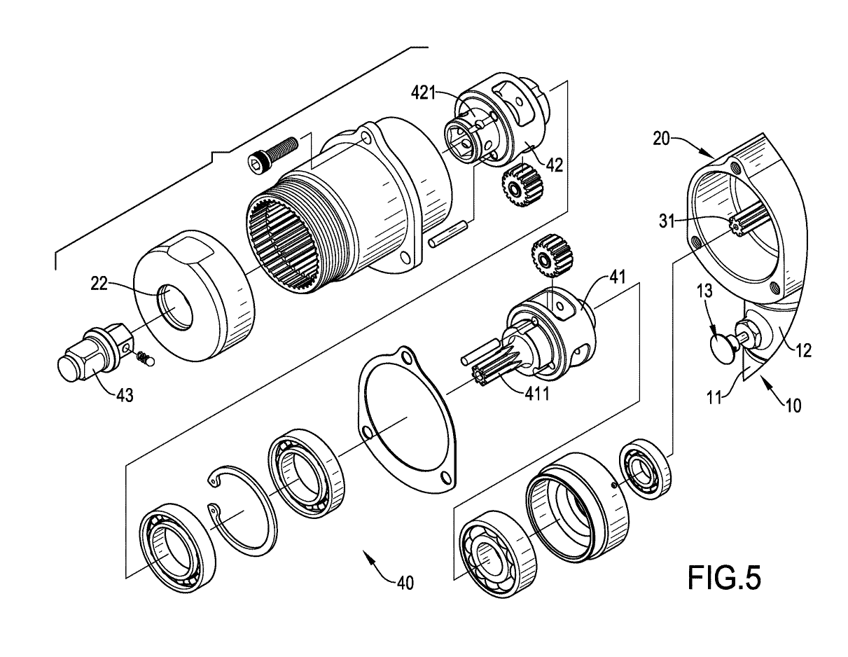

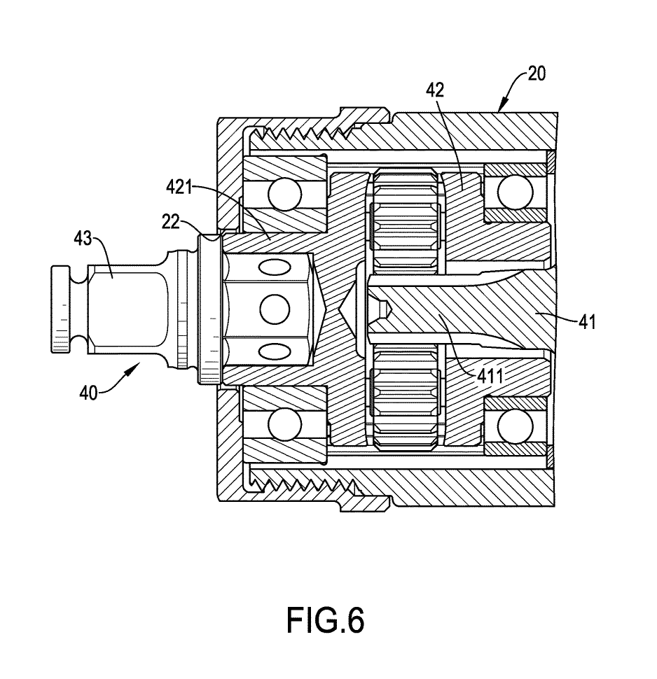

With reference to FIGS. 2, 5, and 6, the tool body 20 is mounted on a top of the handle 10, and comprises an accommodating space 21 and two openings 22. The accommodating space 21 is formed in the tool body 20. The openings 22 are respectively formed through two opposite ends of the tool body 20 and communicating with the accommodating space 21.

The rotator 30, the first working unit 40, and the second working unit 50 are mounted in the accommodating space 21. The rotator 30 comprises a first driving end 31 and a second driving end 32. The first driving end 31 and the second driving end 32 are respectively formed on two opposite ends of the rotator 30. The rotator 30 may be driven by air power or by electrical power. Preferably, the rotator 30 is driven by air power.

The first working unit 40 is mounted around the first driving end 31, and comprises a first speed reduction mechanism 41, a second speed reduction mechanism 42, and a first working connector 43. The first speed reduction mechanism 41 is mounted around and engaged with the first driving end 31, and comprises a connection portion 411. The second speed reduction mechanism 42 is mounted around the connection portion 411, and comprises a connection sleeve 421. The first working connector 43 is detachably engaged with the connection sleeve 421 and protrudes out from one of the openings 22 of the tool body 20. Alternatively, the first speed reduction mechanism 41 and the second speed reduction mechanism 42 may be omitted, and the first working connector 43 is mounted around and engaged with the first driving end 31.

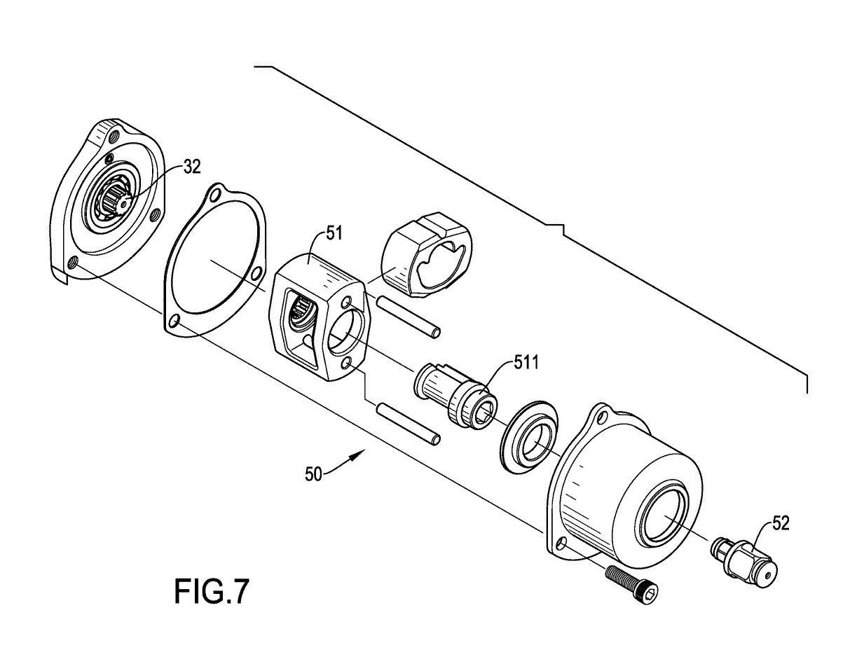

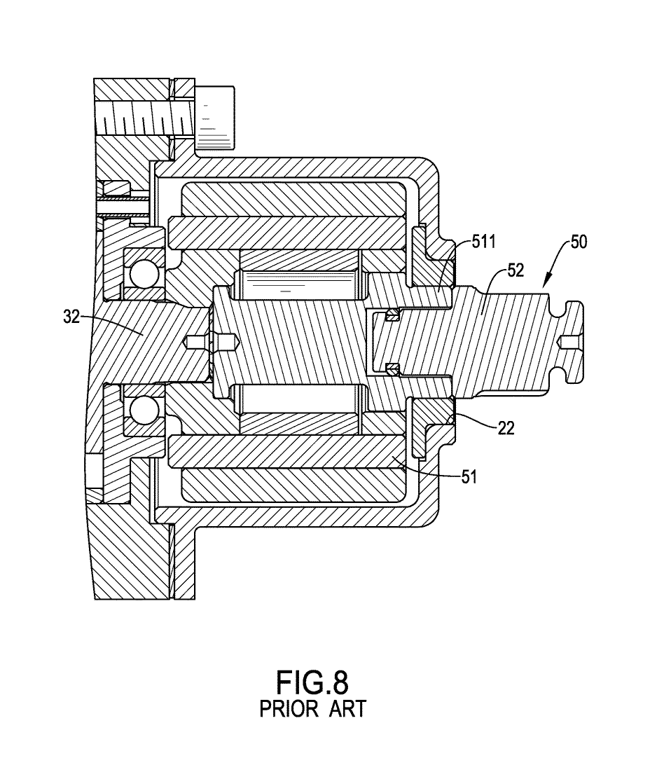

With reference to FIGS. 7 and 8, the second working unit 50 is engaged with the second driving end 32, and comprises a clutch 51 and a second working connector 52. The clutch 51 is mounted around and engaged with the second driving end 32, and comprises a connecting sleeve 511 protruding out from the opening 22 that is opposite the first working unit 40. The mounting ring 12, the switch 13, the first working unit 40, and the second working unit 50 are applied to form a double operational stricture for the power tool, so the power tool can be applied for working in two opposite directions.

In use, a user holds the handle body 11. If the user wants to use the first working unit 40, the mounting ring 12 is rotated, such that the switch 13 and the first working connector 43 are located at a same side of the power tool. For safety in use, the second working connector 52 is detached from the connecting sleeve 511 temporarily. The rotator 30 is controlled to rotate by the switch 13. When the rotator 30 is rotated, the first speed reduction mechanism 41 and the second speed reduction mechanism 42 can reduce the rotation speed which is provided by the rotator 30, such that a torque that is outputted from the rotator 30 can be increased. The torque is inputted toward the first working connector 43, and the first working connector 43 is applied for tightening or loosening a bolt.

If the user wants to use the second working unit 50, the mounting ring 12 is rotated, such that the switch 13 and the second working connector 52 are located at another same side of the power tool. The second working connector 52 is mounted on the connecting sleeve 511. For safety in use, the first working connector 43 is detached from the connection sleeve 421 temporarily. When the rotator 30 is rotated, the clutch 51 transfers a power that is outputted by the rotator 30 toward the second working connector 52. A hammer of the clutch 51 is applied for enhancing the power that is transferred toward the second working connector 52, so the second working connector 52 can be applied on a final process of tightening a bolt, or on a first process of loosening a bolt.

From the above description, it is noted that the present invention has the following advantages: the power tool comprises the double operational structure which comprises the mounting ring 12, the switch 13, the first working unit 40, and the second working unit 50, so the power tool can be applied for double working directions. The working connectors 43, 52 are respectively driven by the first driving end 31 and the second driving end 32, such that the working connectors 43, 52 can be driven in a clockwise direction and a counterclockwise direction. The working connectors 43, 52 may be connected with different work pieces. For example, when the user tightens or loosens a bolt, such as a tire bolt, the user can use the power tool alone to complete the tightening or loosening. A number of tools can be decreased effectively.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A power tool comprising:
a handle comprising
a handle body;
a mounting ring rotatably mounted around the handle body; and
a switch mounted on the mounting ring and inserted into the handle body;
a tool body mounted on the handle, and comprising an accommodating space formed in the tool body;
a rotator mounted in the accommodating space, and comprising
a first driving end formed on an end of the rotator; and
a second driving end opposite the first driving end;
a first working unit mounted in the accommodating space, mounted around and engaged with the first driving end, and comprising a first working connector protruding out from the tool body; and
a second working unit mounted in the accommodating space, mounted around and engaged with the second driving end, and comprising a second working connector protruding out from the tool body.

2. The power tool as claimed in claim 1, wherein the first working unit comprises at least one speed reduction mechanism connected between the first driving end of the rotator and the first working connector.

3. The power tool as claimed in claim 2, wherein the first working connector is detachably connected with the at least one speed reduction mechanism.

4. The power tool as claimed in claim 3, wherein two speed reduction mechanisms are implemented in amount.

5. The power tool as claimed in claim 1, wherein the second working unit comprises a clutch connected between the second driving end and the second working connector.

6. The power tool as claimed in claim 2, wherein the second working unit comprises a clutch connected between the second driving end and the second working connector.

7. The power tool as claimed in claim 6, wherein the second working connector is detachably connected with the clutch.
